(19) United States
(12) Patent Application Publication
(10) Pub. No.: US 2009/0218040 A1
(43) Pub. Date: Sep. 3, 2009

(54) Method of Manufacturing a Sensor for Detecting Surface Cracks in a Structure

(75) Inventor: Nigel Laxton, Western Australia (AU)

Correspondence Address: MEYERTONS, HOOD, KIVLIN, KOWERT & GOETZEL, P.C., P.O. BOX 398, AUSTIN, TX, 78767-0398, US

(73) Assignee: STRUCTURAL MONITORING SYSTEMS LTD

(21) Appl. No.: 12/227,004

(22) PCT Filed: May 3, 2007
(86) PCT No.: PCT/AU2007/000584

§ 371 Date: Mar. 13, 2009

(30) Foreign Application Priority Data
May 3, 2006 (AU) 2006902313

(51) Int. Cl. B32B 37/00; B29C 39/00

(52) U.S. Cl. 156/245; 264/296; 264/299

(57) ABSTRACT

A method of manufacturing a sensor 10 for use in a differential pressure monitoring system comprises forming a body portion 12 of the sensor 10 by delivering a molten material to a mould and forming one or more channels 16 in the body portion 12. The channels 16 open onto a first surface 14 of the body portion that, in use, is affixed to a surface of a component to be monitored. The method further comprises forming connectors with the body portion and providing the connectors with a throughway or passage to provide fluid communication with the channels. The connectors, channels and body portion may all be formed concurrently in the moulding process.

### FIELD OF THE INVENTION

The present invention relates to a method of manufacturing a sensor for detecting surface cracks in a structure, and a sensor that is manufactured in accordance with the method.

### BACKGROUND OF THE INVENTION

It is known to use differential pressure monitoring techniques (also known as “comparative pressure monitoring”) to monitor for the presence of a surface flaw, such as a crack, in a structure or component. Furthermore, it is known to use a sensor pad, which engages the surface of the structure or component to be monitored, together with a monitoring apparatus to establish differential pressure in regions adjacent the surface of the structure or component.

### SUMMARY OF THE INVENTION

According to a first aspect of the present invention, there is provided a method of manufacturing a sensor for use in a differential pressure monitoring system, the method comprising the steps of:
forming a body portion of the sensor by delivering molten material to a mould, the body portion having a first surface that, in use, is affixed to the surface of a component to be monitored; and
forming one or more channels in the body portion, the channels opening onto the first surface.

The channels can be formed concurrently with forming the body portion.

The method may additionally comprise the step of forming one or more connectors that each define a throughway, and bringing each throughway into fluid communication with one of the channels.

The body portion and the connectors can be formed concurrently, such that the body portion and connectors are contiguous.

In one embodiment, the method further comprises delivering an adhesive to the first surface of the body portion, the adhesive, adapted to affix the first surface to the surface of the component.

The method may further comprise providing an adhesive layer comprising a substrate having opposed first and second substrate surface with adhesive applied to both of said first and second substrate surfaces, and affixing the first substrate surface to the first surface with said adhesive.

The method may further comprise forming one or more apertures in the adhesive layer, each of the apertures registering with a respective one of the channels in the body portion.

The aperture may further comprise forming the or each aperture comprises forming the or each aperture of a configuration so that when in registration with a corresponding channel a footprint of channel lies wholly within a footprint of its corresponding aperture.

One embodiment of the method further comprises providing a release liner, and applying the release liner to the adhesive such that the adhesive is covered prior to affixing the sensor to the component.

The release liner may be provided with one or more apertures.

In one embodiment, the apertures in the release liner are formed concurrently with the forming of the apertures in the adhesive layer.

The release liner may be applied to the adhesive prior to forming the apertures in the release liner.

According to a second aspect of the present invention there is provided a sensor that is manufactured in accordance with the method of the first aspect.

### BRIEF DESCRIPTION OF THE DRAWINGS

In order that the invention may be more easily understood, embodiments will now be described, by way of example only, with reference to the accompanying drawings, in which:

FIG. 1 is an axonometric view of a sensor in accordance with a first embodiment of the present invention;

FIG. 2 is an exploded view of the sensor of FIG. 1;

FIG. 3 is a side cross sectional view of the sensor of FIG. 1, as seen along the line A-A of FIG. 1;

FIG. 4 is an enlarged bottom view of the sensor of FIG. 1;

FIG. 5 is an axonometric view of a sensor in accordance with a second embodiment of the present invention;

FIG. 6 is a side cross sectional view of the sensor of FIG. 5, as seen along the line B-B of FIG. 5;

FIG. 7 is a bottom view of the sensor of FIG. 5;

FIG. 8 is an axonometric view of a sensor in accordance with a third embodiment of the present invention;

FIG. 9 is a side cross sectional view of the sensor of FIG. 8, as seen along the line C-C of FIG. 8;

FIG. 10 is an axonometric view of a sensor in accordance with a fourth embodiment of the present invention;

FIG. 11 is a side cross sectional view of the sensor of FIG. 10, as seen along the line D-D of FIG. 10; and

FIG. 12 is a flow chart of a method in accordance with a fifth embodiment of the present invention, the method being for manufacturing a sensor.

### DETAILED DESCRIPTION OF THE PREFERRED EMBODIMENTS

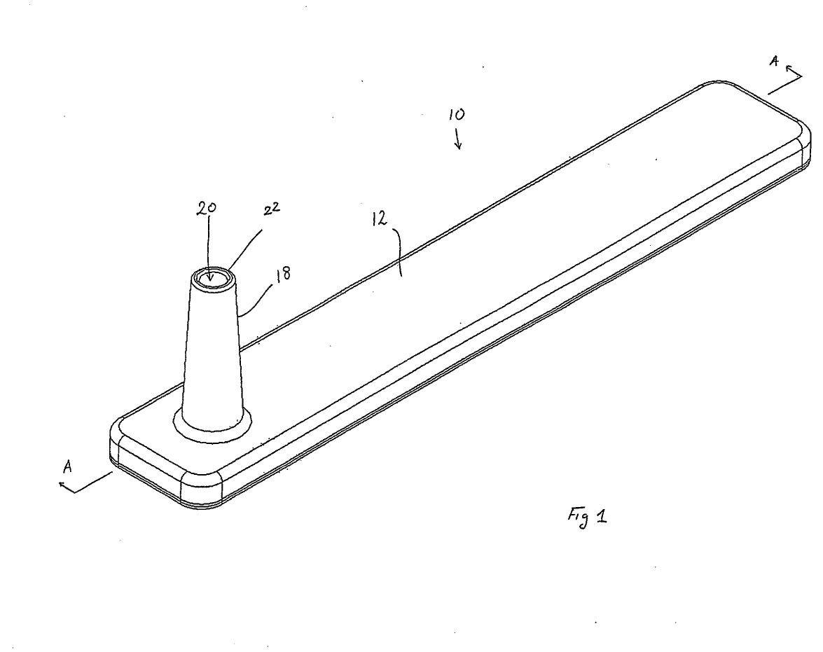

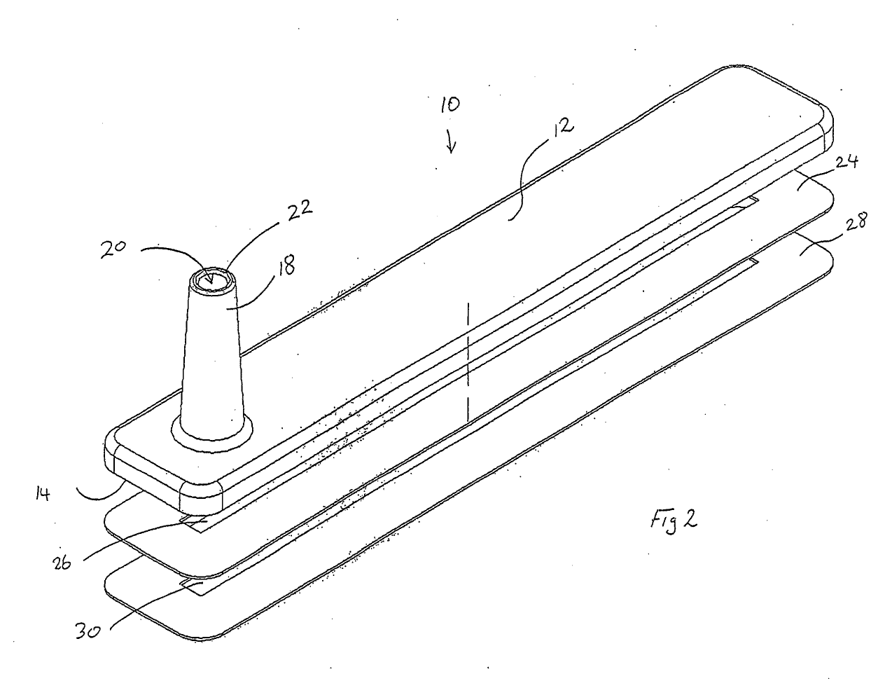

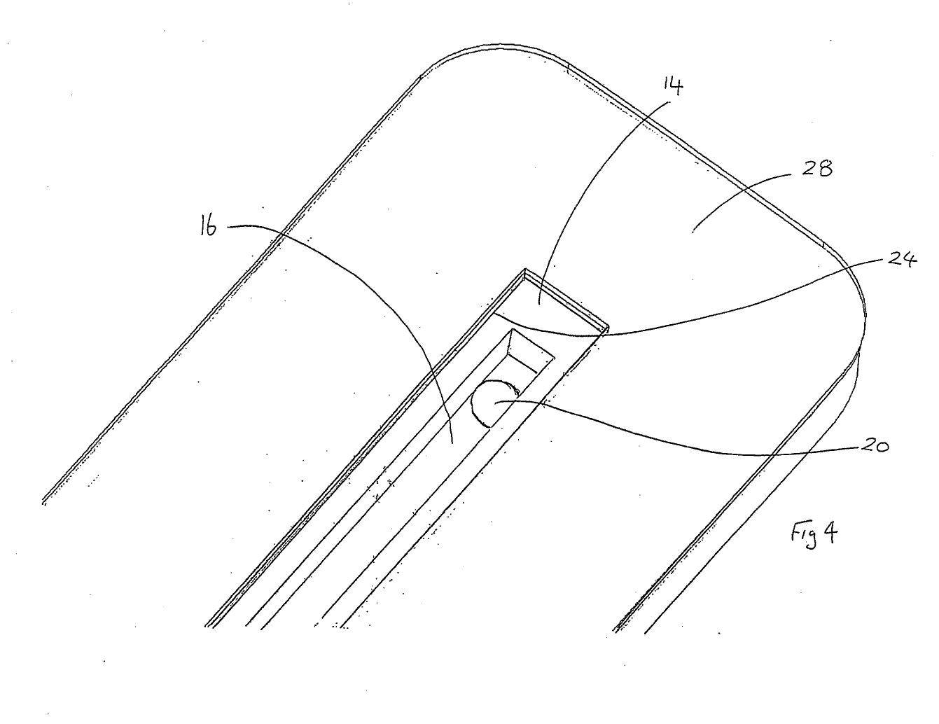

FIGS. 1 to 4 show a sensor 10, in accordance with a first embodiment, for use in a differential pressure monitoring system (not shown). The sensor 10 has a body portion 12 that has a first surface 14, which, in use, is affixed to the surface of a component (not shown) that is to be monitored. In this embodiment, the body portion 12 is generally elongate.

Throughout this specification including the claims, except where the context requires otherwise due to express language or necessary implication the word “affixed” or variations such as “affix” or “affixing” are used to indicate fixing or attaching in a manner the creates or forms a substantially hermetic seal.

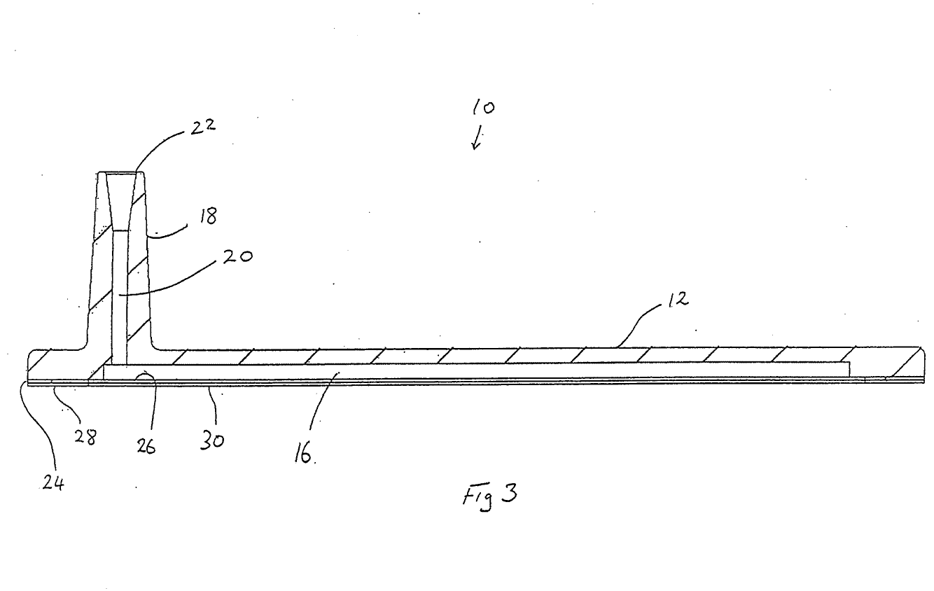

As shown in FIG. 3, a channel 16 is formed within the body portion 12. The channel 16 is open to the first surface 14 such that, when the sensor 10 is affixed to a component, the channel 16 faces the surface of the component. The width of the channel 16 can be 5 mm or less. In some embodiments, the width of the channel 16 can be 0.5 mm or less.

The sensor 10 further has a connector 18 that extends from the body portion 12. The connector 18 defines a throughway (i.e. a passage) 20 that extends between an opening 22 (which is remote from the channel 16) and one end of the channel 16. In this embodiment, an end portion of the throughway 20 is conical and widens towards the opening 22. Accordingly, tubing (not shown) that is used to plumb the sensor 10 into a differential pressure monitoring system can be connected to the sensor by inserting a free end of the tubing into the throughway 20 to establish an interference fit.

In this embodiment, the body portion 12 and connector 18 are contiguous.

An adhesive layer 24 is affixed to the first surface 14 of the sensor 10. In this embodiment, the adhesive layer 24 is in the form of a substrate that has pressure sensitive adhesive (PSA) on two opposing surfaces, a first of which is affixed to the first surface 14 of the body portion 12. Hence, when this embodiment is affixed to the surface of a component, the second surface of the adhesive layer 24 is affixed to, and in contact with, the surface of the component.

The adhesive layer 24 has a peripheral shape that corresponds with the peripheral shape of the first surface of the body portion 12. In addition, the adhesive layer 24 has an aperture 26 that registers with the channel 16 in the body portion 12. The aperture 26 has the same overall shape as the channel 16. In the embodiment shown in FIGS. 1 to 4, the aperture 26 is oversize with respect to the channel 16, in that the aperture 26 is larger in the width and length dimensions when compared to the channel 16.

A release liner 28 is provided to cover the PSA on the second surface of the adhesive layer 24 prior to affixing to the surface of a component. If desired, the release liner 28 may have an aperture 30 that registers with the aperture 26 in the adhesive layer 24.

In use, the sensor 10 is applied to the surface of a component. The pressure sensitive adhesive on the second surface of the adhesive layer 24 affixes the sensor 10 to the surface and forms a seal between the body portion 12 and the surface. The channel 16 and the surface of the component together form a conduit that can be substantially in fluid isolation with respect to atmospheric air. The sensor 10 may be plumbed via the connector 18 to, for example, the instrumentation of a vacuum monitoring system.

A pressure differential can be created in the conduit. A crack in the component that opens onto the surface and intersects the channel 16 will allow fluid to flow through the crack and into the first channel 16. Where a pressure differential exists between two regions of the crack, such a fluid flow will occur. Accordingly, a change in fluid flow (and/or a change in pressure state of the channel 16) can be indicative of the presence of a crack.

The pressure differential maybe relative negative or relative positive differential. That is the pressure in the conduit may be less than ambient pressure (i.e. relative negative) or higher than ambient pressure (i.e. relative positive).

A crack may extend from a region beyond one of the peripheral edges of the sensor 10 and intersect the channel 16. In an embodiment in which there is a pressure differential between the atmosphere surrounding the sensor 10 and the conduit, fluid flow through the crack may occur.

Clearly, the distance between the channel 16 and the peripheral edges of the body portion 12 is a factor that influences the minimum crack length that can be detected by the sensor 10.

The body portion 12 and connector 18 can be made of plastics materials such as thermosets, thermoplastics or elastomers. The body portion 12 and connector 18 can be formed simultaneously by delivering a raw material in a molten state into a female mould having the form the body portion 12 and connector 18. The molten material is then allowed to cool and solidify to form the body portion 12 and connector 18 of the sensor 10. For example, injection moulding may be used.

The adhesive layer 24 may be formed by cutting the peripheral shape of the adhesive layer 24 from a larger sheet of adhesive layer material. Simultaneously or subsequently, the aperture 26 can be created by cutting or otherwise removing material from the adhesive layer 24 to form the aperture 26.

In some embodiments of the sensor, the width of the aperture 26 is to be approximately equal to the width of the channel 16. Accordingly, the width of the aperture 26 may be 0.5 mm or less. It is to be appreciated that for best performance of the sensor 10, the channel 16 should not be obstructed by the adhesive layer 24. Accordingly, in such embodiments of the sensor, a high degree of accuracy in forming the aperture 26 is desirable.

The adhesive layer 24 can then be affixed to the first surface of the body portion 12.

The release liner 28 may also be formed by cutting the peripheral shape of the release liner 28 from a larger sheet of release liner material. The aperture 28 can be created simultaneously or subsequently by cutting or otherwise removing material from the release liner 28 to form the aperture 28. The adhesive layer 24 and release liner 28 can be provided together in a larger sheet such that the peripheral shape and respective peripheral shapes are formed together. Alternatively, the release liner 28 can be applied to the surface of the adhesive layer 24 after the release liner 28 has been formed.

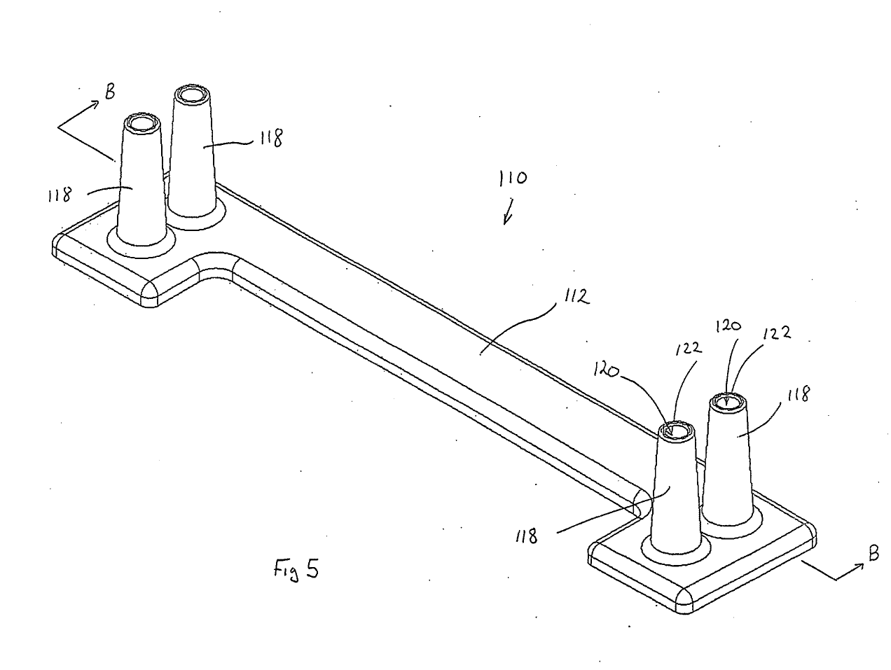

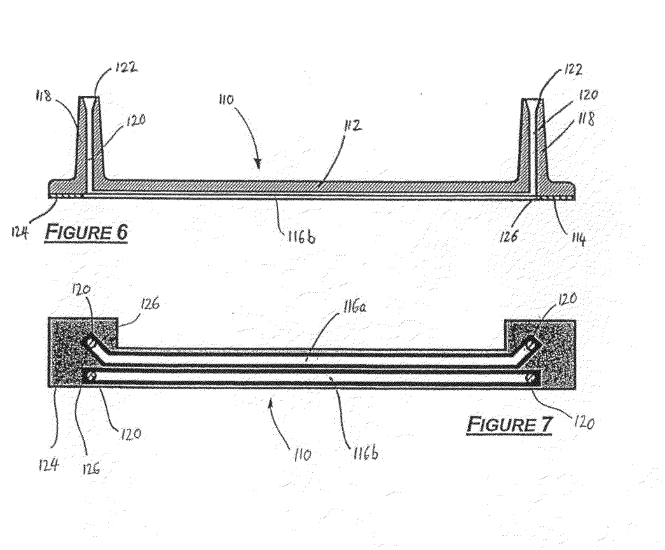

In some embodiments, it may be desired to provide the adhesive layer material with a release liner material covering the PSA on both surfaces of the adhesive layer material. In such an embodiment, it may also be convenient to cut or otherwise form the adhesive layer 24 and with two like release liners 28, a first of which is removed to affix the adhesive layer 24 to the body portion 12, and a second of which may be removed immediately prior to affixing the sensor 10 to the surface of a component. Alternative sensor shapes and/or structures may be manufactured as described above in connection with the sensor 10. Three such alternative embodiments of the sensor are described below in reference to FIG. 5 to 11.

FIGS. 5 to 7 show a sensor 110, in accordance with a second embodiment, for use in a differential pressure monitoring system (not shown). The sensor 10 has a body portion 112 that has a first surface 114, which, in use, is affixed to the surface of a component (not shown) that is to be monitored. In this embodiment, the body portion 112 is generally elongate.

As shown in FIG. 7, two channels 116a, 116b (hereinafter referred to collectively as “channels 116”) are formed within the body portion 112. The channels 116 open onto the first surface 114 such that, when the sensor 110 is affixed to a component, the channels 116 face the surface of the component.

The sensor 110 further has four connectors 118 that extend from the body portion 112. The connectors 118 each define a throughway 120 that extends between an opening 122 (which is remote from the first surface 114) and one end of a respective one of the channels 116. In this embodiment, an end portion of each throughway 120 is conical and widens towards the opening 122. Accordingly, tubing (not shown) that is used to plumb the sensor 110 into a differential pressure monitoring system can be connected to the sensor by inserting a free end of the tubing into the throughway 120 to establish an interference fit.

The quality of the interference fit between the tubing and the connector 118 can influence the reliability of the sensor 110. Factors that influence the quality of the interference fit include the opening angle of the conical end portion of the throughway 128, the relative dimensions of the tubing and the end portion of the throughway 128, the material properties (such as relative stiffness) of the connector 118 and the tubing, and the tubing and the presence of surface imperfections in the throughway 128 and tubing.

An adhesive layer 124 is affixed to the first surface 114 of the sensor 110. In this embodiment, the adhesive layer 124 is in the form of a substrate that has pressure sensitive adhesive (PSA) on two opposing surfaces, a first of which is affixed to the first surface 114 of the body portion 112. Hence, when this embodiment is affixed to the surface of a component, the second surface of the adhesive layer 124 is affixed to, and in contact with, the surface of the component.

The adhesive layer 124 has a peripheral shape that corresponds with the peripheral shape of the first surface of the body portion 112. In addition, the adhesive layer 124 has two apertures 126 that each register with one of the channels 116 in the body portion 112. Each aperture 126 has the same overall shape as the respective channel 116.

A release liner (not shown) may be provided to cover the PSA on the second surface of the adhesive layer 124 prior to attachment to the surface of a component. If desired, the release liner may also have an apertures that register with the apertures 126 in the adhesive layer 124.

In use, the sensor 110 is applied to the surface of a component. The pressure sensitive adhesive on the second surface of the adhesive layer 124 affixes the sensor 110 to the surface and forms a seal between the body portion 112 and the surface. Each of the channels 116a, 116b and the surface of the component together form respective conduits which can be insubstantial fluid isolation with respect to atmospheric air. Accordingly, in this embodiment there are two such conduits. The sensor 110 may be plumbed via the connectors 118 to, for example, the instrumentation of a vacuum monitoring system.

A pressure differential can be created in one or both of the channels 116. A crack in the component that opens onto the surface and intersects one or both of the channels 116 will allow fluid flow between the crack and the respective channels 116. Where a pressure differential exists between two regions of the crack, such a fluid flow will occur. Accordingly, a change in fluid flow (and/or a change in pressure state of the respective channels 116) can be indicative of the presence of a crack.

A crack may extend from a region beyond one of the peripheral edges of the sensor 110 and intersect one or both of the channels 116. In an embodiment in which there is a pressure differential between the atmosphere surrounding the sensor 110 and the conduits, fluid flow through the crack may occur.

Alternatively or additionally, a crack may intersect the channels 116. In an embodiment in which there is a pressure differential between the conduits, fluid flow through the crack may occur.

Each of the conduits formed by the channels 116 and the surface of the component is continuous between its two respective connectors 118. Thus, it is possible to test for a blockage in the conduits. A blockage indicates that continuity does not exist through the conduit, and that portions of the sensor 110 are inactive. Clearly, a crack that intercepts an inactive portion of the conduit will not be detected. For example, a continuity test of a conduit may be achieved by introducing fluid into a first of the connectors 118 and monitoring the steady state flow of fluid exhausted via the corresponding other connector 118.

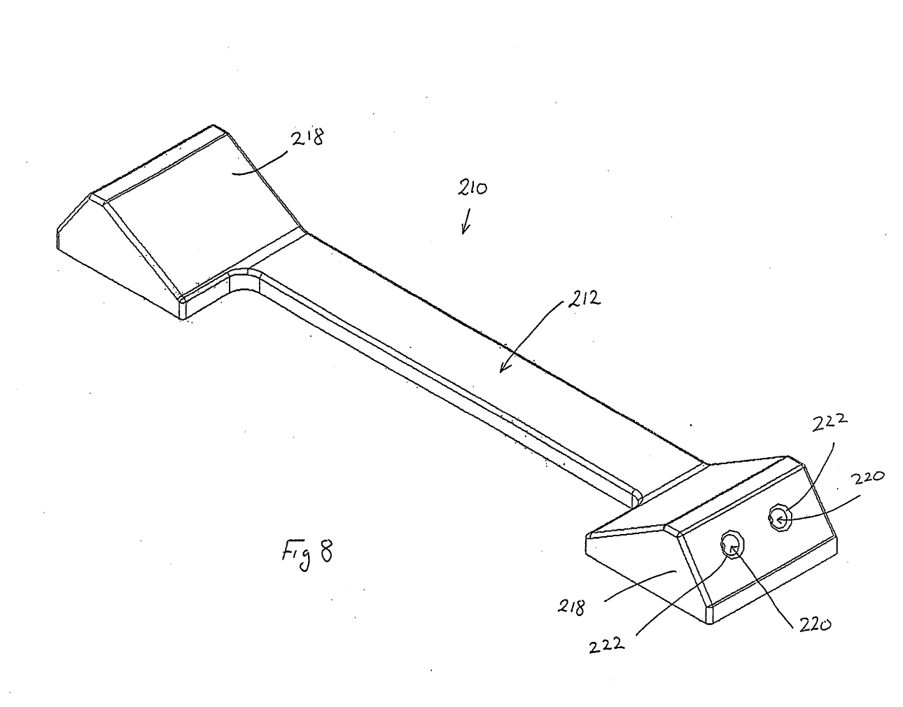

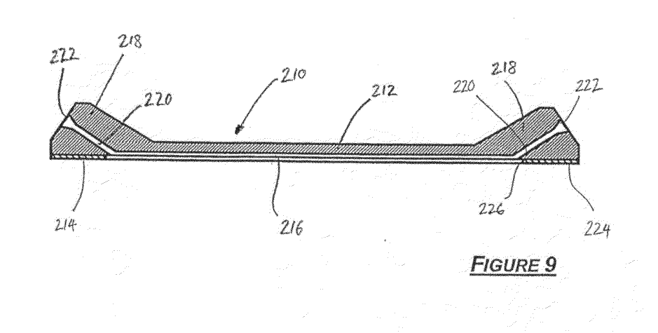

FIGS. 8 and 9 show a sensor 210, in accordance with a third embodiment, for use in a differential pressure monitoring system (not shown). The sensor 210 has a body portion 212 that has a first surface 214, which, in use, is affixed to the surface of a component (not shown) that is to be monitored. In this embodiment, the body portion 212 is generally elongate.

The sensor 210 is provided with two channels 216 that are formed within the body portion 212. The channels 216 open onto the first surface 214 such that, when the sensor 210 is affixed to a component, the channels 216 face the surface of the component.

The sensor 210 further has two connectors 218 that are contiguous with the body portion 212. The connectors 218 each define a pair of throughways 220 that each extends between an opening 222 (which is remote from the first surface 214) and one end of a respective one of the channels 216. In this embodiment, an end portion of each throughway 220 is conical and widens towards the opening 222. Accordingly, tubing (not shown) that is used to plumb the sensor 210 into a differential pressure monitoring system can be connected to the sensor 210 by inserting a free end of the tubing into the throughway 220 to establish an interference fit.

The connectors portions 218 allow the tubing to extend from the sensor 210 at an acute angle to the first surface 214. Thus, the “take-off” angle of the tubing is also at an acute angle to the surface of the component to be monitored.

An adhesive layer 224 is affixed to the first surface 214 of the sensor 210. In this embodiment, the adhesive layer 224 is in the form of a substrate that has pressure sensitive adhesive (PSA) on two opposing surfaces, a first of which is affixed to the first surface 214 of the body portion 212. Hence, when this embodiment is affixed to the surface of a component, the second surface of the adhesive layer 224 is affixed to, and in contact with, the surface of the component.

The adhesive layer 224 has a peripheral shape that corresponds with the peripheral shape of the first surface 214 of the body portion 212. In addition, the adhesive layer 224 has two apertures that each register with one of the channels 216 in the body portion 212. Each aperture has the same overall shape as the respective channel 216.

A release liner (not shown) may be provided to cover the PSA on the second surface of the adhesive layer 224 prior to attachment to the surface of a component. If desired, the release liner may also have an apertures that register with the apertures 226 in the adhesive layer 224.

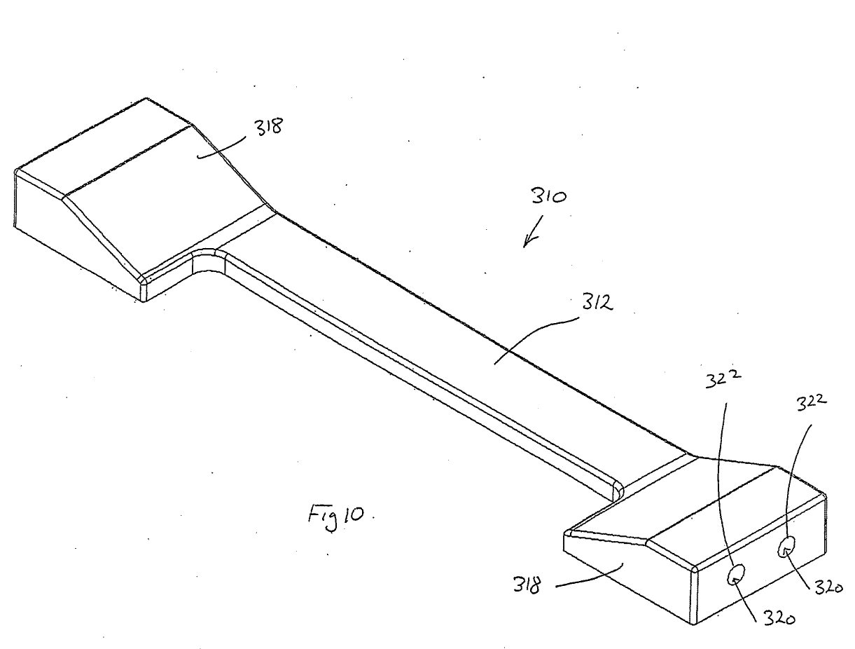

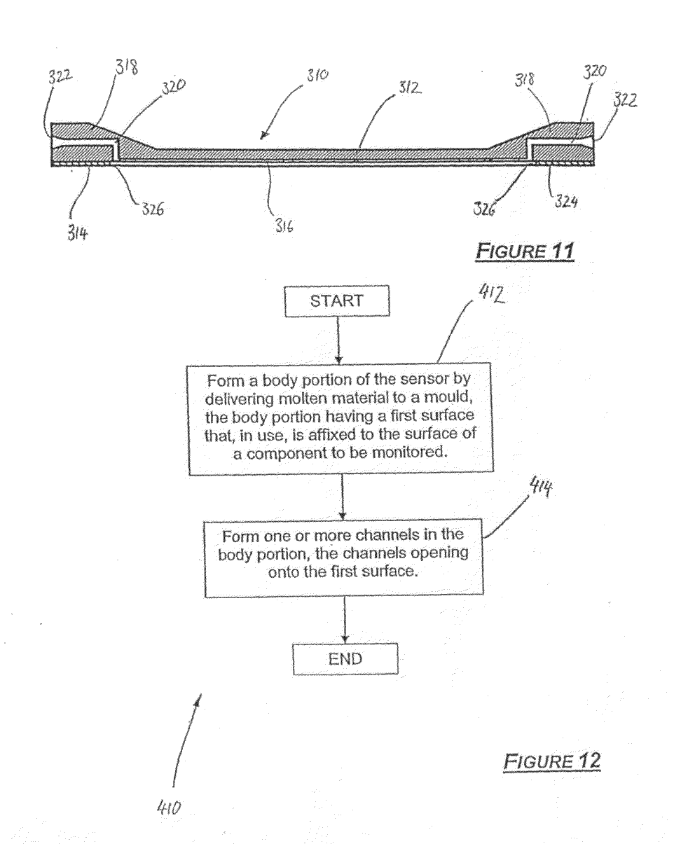

FIGS. 10 and 11 show a sensor 310, in accordance with a third embodiment, for use in a differential pressure monitoring system (not shown). The sensor 310 has a body portion 312 that has a first surface 314, which, in use, is affixed to the surface of a component (not shown) that is to be monitored. In this embodiment, the body portion 312 is generally elongate.

The sensor 310 is provided with two channels 316 that are formed within the body portion 312. The channels 316 open onto the first surface 314 such that, when the sensor 310 is affixed to a component, the channels 316 face the surface of the component.

The sensor 310 further has two connectors 318 that are contiguous with the body portion 312. The connectors 318 each define a pair of throughways 320 that each extends between an opening 322 (which is remote from the first surface 314) and one end of a respective one of the channels 316. In this embodiment, an end portion of each throughway 320 is conical and widens towards the opening 322. Accordingly, tubing (not shown) that is used to plumb the sensor 310 into a differential pressure monitoring system can be connected to the sensor 310 by inserting a free end of the tubing into the throughway 320 to establish an interference fit.

The connectors portions 318 allow the tubing to extend from the sensor 310 in a direction that is generally parallel with the first surface 314. Thus, the “take-off” angle of the tubing is also generally parallel to the surface of the component to be monitored.

An adhesive layer 324 is affixed to the first surface 314 of the sensor 310. In this embodiment, the adhesive layer 324 is in the form of a substrate that has pressure sensitive adhesive (PSA) on two opposing surfaces, a first of which is affixed to the first surface 314 of the body portion 312. Hence, when this embodiment is affixed to the surface of a component, the second surface of the adhesive layer 324 is affixed to, and in contact with, the surface of the component.

The adhesive layer 324 has a peripheral shape that corresponds with the peripheral shape of the first surface 314 of the body portion 312. In addition, the adhesive layer 324 has two apertures that each register with one of the channels 316 in the body portion 312. Each aperture has the same overall shape as the respective channel 316.

A release liner (not shown) may be provided to cover the PSA on the second surface of the adhesive layer 324 prior to attachment to the surface of a component. If desired, the release liner may also have an apertures that register with the apertures 326 in the adhesive layer 324.

It is to be appreciated that the volume of the conduit(s) formed by the channel(s) will influence the sensitivity of sensor. Accordingly, the dimensions of the channel(s) may require matching to the desired sensitivity of the sensor and measurement system. In some embodiments the channel(s) may have a width of 5 mm or less. In some embodiments, the width of the channel(s) can be 1 mm or less.

FIG. 12 shows a flow chart 410 in accordance with a fifth embodiment of the invention. The flow chart 410 illustrates a method for manufacturing a sensor for use in a differential pressure monitoring system. The sensor may be, for example, the sensors illustrated in FIGS. 1 to 11.

The method includes the step 412 of forming a body portion of the sensor by delivering molten material to a mould. The body portion has a first surface that, in use, is affixed to the surface of a component to be monitored.

The method also includes the step 414 of forming one or more channels in the body portion. The channels open onto the first surface. Accordingly, when the sensor is affixed to the surface of a component, channels open onto the surface of the component.

It will be understood to persons skilled in the art of the invention that many modifications may be made without departing from the scope of the invention.

In the embodiments described in reference to FIGS. 1 to 11, the pressure sensitive adhesive is provided on a substrate such that the adhesive is transferred to the body portion by the substrate. Alternatively, pressure sensitive adhesive may be applied to the first surface of the body portion. This may be achieved by spraying the PSA directly onto the first surface. It will be appreciated that spraying adhesive onto the first surface may result in adhesive being directed into the channel(s). In some embodiments this may be problematic as the PSA may cause blockages in the channel(s). A mask may be provided to minimise the amount of PSA directed into the channel(s).

In a further alternative, the pressure sensitive adhesive may be dispersed within a formulation containing a curable adhesive, such as structural adhesive, which is in the form of a thin stratum. The stratum is applied to the first surface of the body portion. The PSA within the curable adhesive allows the sensor to be removed and repositioned prior to the curable adhesive being cured.

It is to be appreciated that the connector(s) and the throughway(s) may be of any desired shape and structure, provided that the connectors fulfill the function of bringing the channel(s) of the sensor in fluid communication with the tubing that plumbs the sensor into the monitoring system. Furthermore, the connection(s) should also form a substantial hermetic seal.

In one alternative embodiment, the connector(s) may be in the form of a rigid tube that registers with a respective throughway. The rigid tube(s) can be inserted into the mould cavity prior to delivery of the body portion/connector material. Accordingly, during the moulding step the rigid tube is affixed within the throughway. In a further alternative embodiment, the throughway(s) may be provided with an internal thread that engages a complementary thread on a secondary connector. The internal thread may be formed during the moulding step, or alternatively subsequent to the body portion

The channel(s) in the body portion may be formed during the step of moulding the body portion by providing female channel elements within the die. Alternatively, the channels may be formed subsequent to the forming of the body portion. The channel(s) may be formed by removing and/or cutting or otherwise ablating material from the body portion following the moulding step.

As described previously, in embodiments of the sensor in which the PSA is transferred to the first surface of the body portion, the apertures in the adhesive layer and/or release liner may be formed by cutting material from the adhesive layer and/or release liner. Alternatively, the apertures may be formed by ablating material from the adhesive layer and/or release liner using, for example, laser ablation. This may be of advantage for achieving appropriate dimensional tolerancing in narrow apertures. Alternatively, an adhesive layer and/or release liner, without apertures formed therein, may be applied to the first surface of the body portion. Subsequently, the apertures in the adhesive layer and/or release liner may be formed by ablating material. In some embodiments, the channel(s) in the body portion may be formed simultaneously with the forming of the apertures in the adhesive layer and/or release liner by ablating material from the adhesive layer and/or release liner, and the body portion.

In one alternative embodiment, the body portion may be formed using transfer moulding, in which the female mould is at least partially heated as the molten material is delivered into the mould.

It is to be appreciated that the connector(s) of the sensor may be formed separately of the body portion and subsequently joined to the body portion.

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

1. A method of manufacturing a sensor for use in a differential pressure monitoring system, the method comprising the steps of:
forming a body portion of the sensor by delivering molten material to a mould, the body portion having a first surface that, in use, is affixed to the surface of a component to be monitored; and
forming one or more channels in the body portion, the channels opening onto the first surface.

2. The method according to claim 1 wherein the forming of the body portion and the forming of the or each channel are performed concurrently.

3. The method according to claim 1 further comprising forming one or more connectors that each define a throughway, and bringing each throughway into fluid communication with one of the channels.

4. The method according to claim 3 further comprising concurrently forming the body portion with the connectors such that the body portion and connectors are contiguous.

5. The method according to claim 3 wherein said forming one or more connectors comprises forming the connectors separately from said body portion.

6. The method according to claim 5 wherein said bringing each throughway into fluid communication with one of said channels comprises inserting one end of the or each connector into the mould while the molten material is in a molten state.

7. The method according to claim 1 further comprising delivering an adhesive to the first surface of the body portion, the adhesive, adapted to affix the first surface to the surface of the component.

8. The method according to claim 1 further comprising providing an adhesive layer comprising a substrate having opposed first and second substrate surfaces with adhesive applied to both of said first and second substrate surfaces, and affixing the first substrate surface to the first surface with said adhesive.

9. The method according to claim 7 further comprising forming one or more apertures in the adhesive layer, each of the apertures registering with a respective one of the channels in the body portion.

10. The method according to claim 9 wherein forming the or each aperture comprises forming the or each aperture of a configuration so that when in registration with a corresponding channel a footprint of channel lies wholly within a footprint of its corresponding aperture.

11. The method according to claim 7 further comprising providing a release liner, and applying the release liner to the adhesive such that the adhesive is covered prior to affixing the sensor to the component.

12. The method according to claim 11 further comprising providing one or more apertures in the release line which coincide with the apertures in the adhesive.

13. The method according to claim 12 further comprising concurrently forming the apertures in the adhesive layer and the apertures in the release liner.

14. The method according to claim 8 further comprising forming one or more apertures in the adhesive layer, each of the apertures registering with a respective one of the channels in the body portion.

15. The method according to claim 14 wherein forming the or each aperture comprises forming the or each aperture of a configuration so that when in registration with a corresponding channel a footprint of channel lies wholly within a footprint of its corresponding aperture.
